(19) United States
(12) Patent Application Publication
(10) Pub. No.: US 2013/0227385 A1
(43) Pub. Date: Aug. 29, 2013

(54) METHOD OF ALLOWING A WORD PROCESSING PROGRAM TO BE USED ONLY WITH AN EMBEDDED DOCUMENT

(71) Applicant: Jacob Allen, Rochester Hills, MI (US)

(72) Inventor: Jacob Allen, Rochester Hills, MI (US)

(21) Appl. No.: 13/403,067

(22) Filed: Feb. 23, 2012

(51) Int. Cl. G06F 17/20

(52) U.S. Cl. 715/209

(57) ABSTRACT

A template a setting forth document is imbedded into a word processing computer program and a portion of the document is drafted in the template including a fixed section not be changed by a subsequent user. A coded connection is embedded between the word processing computer program and the fixed section sent to a subsequent user for preventing use of the word processing computer program with documents other than the sent document.

### BACKGROUND OF THE INVENTION

1. Field of the Invention

A method of allowing a word processing program to be used only with an embedded document.

2. Description of the Prior Art

It is known to imbed a template setting forth document in a word processing computer program.

### SUMMARY OF THE INVENTION

The subject invention provides for such a method distinguished by the combination of steps: drafting a portion of the document in the template including a fixed section not be changed by a subsequent user, and embedding a computer coded connection between the word processing computer program and the fixed section sent to a subsequent user for preventing use of the word processing computer program with documents other than the sent document.

### ADVANTAGES OF THE INVENTION

Thus several advantages of the invention allows the owner of a word processing program transferring a document having affixed portion not to be changed by subsequent users to commercially exploit a unique word processing program in segregated one time uses, i.e., use only with that document in which the fixed portion appears.

### BRIEF DESCRIPTION OF THE DRAWINGS

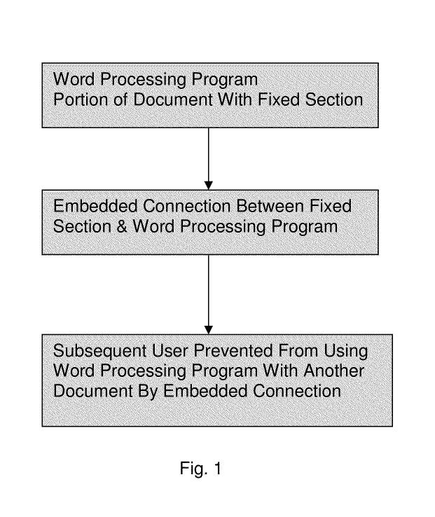

Other advantages of the present invention will be readily appreciated, as the same becomes better understood by reference to the following detailed description when considered in connection with the accompanying drawings wherein FIG. 1 is a patent flow chart showing the steps used in the instant invention.

### DETAILED DESCRIPTION OF THE ENABLING EMBODIMENTS

Accordingly, this invention provides a method of allowing a word processing program to be used only with an embedded document. The method comprises imbedding a template setting forth document in a word processing computer program. The word processing program may be like the one set forth at patentarchitect.com wherein the word processing program is dedicated to preparing a patent application. The fixed portion of the document could be the claims section of the document which are not to be changed when the document is sent to the inventor for editing with a version of the dedicated word processing program. In other words, the inventor would be prevented from using the dedicated word processing program except the patent application with which the claims are included.

Accordingly, a portion of the document is drafted in the template including a fixed section not be changed by a subsequent user. In the case of a patent application, a portion of the application may be prepared by a professional for the inventor to finish and the fixed section would be the claims which are not to be changed by the inventor.

In addition, a computer coded connection is embedded between the word processing computer program and the fixed section sent to a subsequent user for preventing use of the word processing computer program with documents other than the sent document. In the example of a patent application, the professional may send the portion of the application to the inventor embedded in the dedicated word processing program but with a coded connection between the fixed claims section and the dedicated word processing program to prevent the inventor from using the dedicated word processing program with another patent application or document.

In a more specific sense, the computer coded connection could be coded to disable the use of the word processing computer program in response to the fixed section being changed more than a minor percentage. In the example, the disablement could be in response to the claims being changed more than a certain percentage.

This method would allow the portion of the document in and with the word processing computer program to be sent via the internet to the subsequent user for completion using the word processing computer program. In the example, a partially completed patent application could be sent via the internet in the dedicated word processing program but with the coded connection to prevent the inventor from using the dedicated word processing program with another patent application.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. This separation of the new from the old by a coded phrase in the claims should not be interpreted as limiting the performance of the steps in any specific order, i.e., the steps may be performed in any order and/or simultaneously. In addition, the reference numerals in the claims are merely for convenience and are not to be read in any way as limiting.

What is claimed is:

1. A method of allowing a word processing program to be used only with an embedded document comprising;
imbedding a template setting forth document in a word processing computer program, and characterized by
drafting a portion of the document in the template including a fixed section not be changed by a subsequent user,
embedding a computer coded connection between the word processing computer program and the fixed section sent to a subsequent user for preventing use of the word processing computer program with documents other than the sent document.

2. A method as set forth in claim 1 wherein the embedding a computer coded connection being further defined as disabling the use of the word processing computer program in response to the fixed section being changed more than a minor percentage.

3. A method as set forth in claim 2 including sending via the internet the portion of the document in and with the word processing computer program to the subsequent user for completion using the word processing computer program.
